(19) United States
(12) Patent Application Publication
(10) Pub. No.: US 2016/0192349 A1
(43) Pub. Date: Jun. 30, 2016

(54) UPLINK CONTROL CHANNEL

(71) Applicant: Sony Corporation, Tokyo (JP)

(72) Inventors: Na Wei, Beijing (CN); Yong Li, Beijing (CN); Wentao Liu, Beijing (CN)

(21) Appl. No.: 14/618,157

(22) Filed: Feb. 10, 2015

(30) Foreign Application Priority Data
Dec. 24, 2014 (CN) PCT/CN2014/094819

(51) Int. Cl. H04W 72/04

(52) U.S. Cl. CPC H04W 72/0413

(57) ABSTRACT

A subframe (201-2, 201-5) is transmitted from a communication device to a cellular network. The subframe (201-2, 201-5) selectively includes an uplink control channel (265) in a slot (211).

### TECHNICAL FIELD

Various embodiments relate to techniques of transmitting a subframe, the subframe selectively including an uplink control channel in a slot.

### BACKGROUND

Techniques of Dual Connectivity (DC) allow for so-called small cell enhancement of cellular networks. In DC scenarios, a communication device (UE) is typically simultaneously connected to, both, a master access node and a secondary access node of an air interface of the cellular network.

In DC, radio resources of the UE are typically controlled by two distinct schedulers located in the master access node and the secondary access node. Radio resource control signaling is typically handled by the master access node and user plane data can be transmitted between the UE and, both, the master access node and the secondary access node. A situation may arise where a backhaul link between the master access node and the secondary access node is non-ideal so that signaling delay between the access nodes can be high and the bit rate can be limited. In such case, it is it may not be possible or only possible to a limited degree to exchange uplink control information between two nodes.

Sometimes, a situation may occur where the UE does not support uplink carrier aggregation; i.e., the UE may not support establishing of a radio link with, both, the master access node and the secondary access node at a given moment in time. Then, in order for the UE to support DC, mechanisms of maintaining dual links employing a single radio frequency (RF) sending stage (RF-TX) of a wireless interface of the UE may be required; these mechanisms typically rely on separate and sequential uplink transmission to the master access node and the secondary access node. Here, it may be required that the RF-TX is re-tuned from time to time between carrier frequencies corresponding to the uplink transmission to the master access node and the uplink transmission to the secondary access node. Hence, if the UE has a single RF-TX, the UE is typically only able to connect to either the master access node or the secondary access node for uplink transmission at a given moment in time; such a scenario is sometimes referred to time-division multiplexing.

Here, a certain switching time between the uplink transmission to the master access node and the uplink transmission to the secondary access node may be required. Typically, the RF-TX cannot be switched instantaneously between the corresponding frequencies or frequency bands. Oscillators may have to be retuned and/or RF switches may have to be actuated.

The switching time typically degrades the availability of capacity for the uplink transmission. The switching time may not be used for data transmission. Thus, during switching it may not be possible or only possible to a limited degree to send a subframe, the subframe including data packets carrying payload and/or control information. In particular, the switching degrades the availability of capacity on an uplink control channel included in the subframe.

### SUMMARY

Hence, a need exists for implementing advanced techniques of transmitting a subframe including an uplink control channel.

This need is met by the features of the independent claims. The features of the dependent claims define embodiments.

According to an embodiment, a communication device is provided. The communication device comprises a wireless interface and at least one processor. The wireless interface is configured to communicate with a cellular network. The at least one processor is configured to send, via the wireless interface, a slot of a subframe. The subframe selectively includes an uplink control channel in the slot. The wireless interface is configured to mute uplink transmission to the cellular network in a further slot of the subframe.

According to a further embodiment, a method is provided. The method comprises at least one processor of a communication device sending, via a wireless interface of the communication device, a slot of a subframe. The subframe selectively includes an uplink control channel in the slot. The method further comprises the wireless interface muting uplink transmission to the cellular network in a further slot of the subframe.

According to a further embodiment, an air interface of a cellular network is provided. The air interface comprises at least one access node configured to communicate with a communication device. The air interface further comprises at least one processor.

The at least one processor is configured to receive, via a wireless interface of the at least one access node, a slot of a subframe from the communication device. The subframe selectively includes an uplink control channel in the slot.

According to a further aspect, a method is provided. The method comprises at least one processor of an air interface of a cellular network receiving, via a wireless interface of at least one access node of the interface, a slot of a subframe from a communication device. The subframe selectively includes an uplink control channel in the slot.

According to a further aspect, a system is provided. The system comprises a communication device and an air interface of a cellular network. The communication device comprises a wireless interface and at least one processor. The wireless interface of the communication device is configured to communicate the cellular network. The at least one processor of the communication device is configured to send, via the wireless interface of the communication device, a slot of a subframe. The subframe selectively includes an uplink control channel in the slot. The wireless interface of the communication device is configured to mute uplink transmission to the cellular network in a further slot of the subframe. The air interface of the cellular network comprises at least one access node and at least one processor. The at least one access node of the air interface is configured to communicate with the communication device. The at least one processor of the air interface is configured to receive, via a wireless interface of the at least one access node, the slot of the subframe from the communication device.

It is to be understood that the features mentioned above and features yet to be explained below can be used not only in the respective combinations indicated, but also in other combinations or in isolation, without departing from the scope of the present invention. Features of the above-mentioned aspects and embodiments may be combined with each other in other embodiments.

### BRIEF DESCRIPTION OF THE DRAWINGS

The foregoing and additional features and effects of the invention will become apparent from the following detailed description when read in conjunction with the accompanying drawings, in which like reference numerals refer to like elements.

FIG. 1 shows a DC scenario of uplink transmission between a UE and a master access node and a secondary access node of an air interface of a cellular network.

FIG. 2 illustrates schematically a subframe comprising a slot and a further slot, wherein the subframe includes an uplink control channel.

FIG. 3 illustrates a sequence of subframes sent to the master access node and the secondary access node, respectively, some of the subframes selectively including the uplink control channel in the slot according to various embodiments.

FIG. 4 illustrates a sequence of subframes sent to the master access node and the secondary access node, respectively, some of the subframes selectively including the uplink control channel in the slot according to various embodiments.

FIG. 5 illustrates uplink control information sent via the uplink control channel selectively included in the slot of the subframe according to various embodiments.

FIG. 6 shows encoding of the uplink control information sent via the uplink control channel selectively included in the slot of the subframe according to various embodiments, the slot preceding the further slot of the subframe.

FIG. 7 shows encoding of the uplink control information sent via the uplink control channel selectively included in the slot of the subframe according to various embodiments, the slot succeeding the further slot of the subframe.

FIG. 8 illustrates a mapping of downlink data packets transmitted from the cellular network to the communication device as downlink transmission and the control information sent via the uplink control channel according to various embodiments.

FIG. 9 is a flowchart of a method according to various embodiments.

FIG. 10 is a flowchart of a method according to various embodiments.

FIG. 11 is a schematic representation of the UE according to various embodiments.

FIG. 12 is a schematic representation of the master access node and the secondary access node according to various embodiments.

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of transmitting a subframe from an UE to a cellular network, the subframe selectively including an uplink control channel in a slot, are discussed. E.g., the subframe may comprise a slot and a further slot. It is possible that the subframe consists of the slot and the further slot and does not include still further slots. The subframe may be part of a frame of given length. By providing the frame of the given length, synchronisation of uplink transmission from the UE to the cellular network may be achieved. Selectively including the uplink control channel in the slot may refer to not including the uplink control channel in one or more further slots of the subframe.

Hereinafter, various embodiments will be explained primarily in the context of the Third Generation Partnership Project (3GPP) Long Term Evolution (LTE) radio access technology. Similar techniques may be readily applied to different radio access technologies, e.g., the 3GPP Universal Mobile Telecommunications System (UMTS) radio access technology.

According to the 3GPP LTE radio access technology, the frame may have a length of 10 ms. The frame may include ten subframe; each subframe, in turn, may be defined with respect to two subsequent slots, each slot having a duration of 0.5 ms.

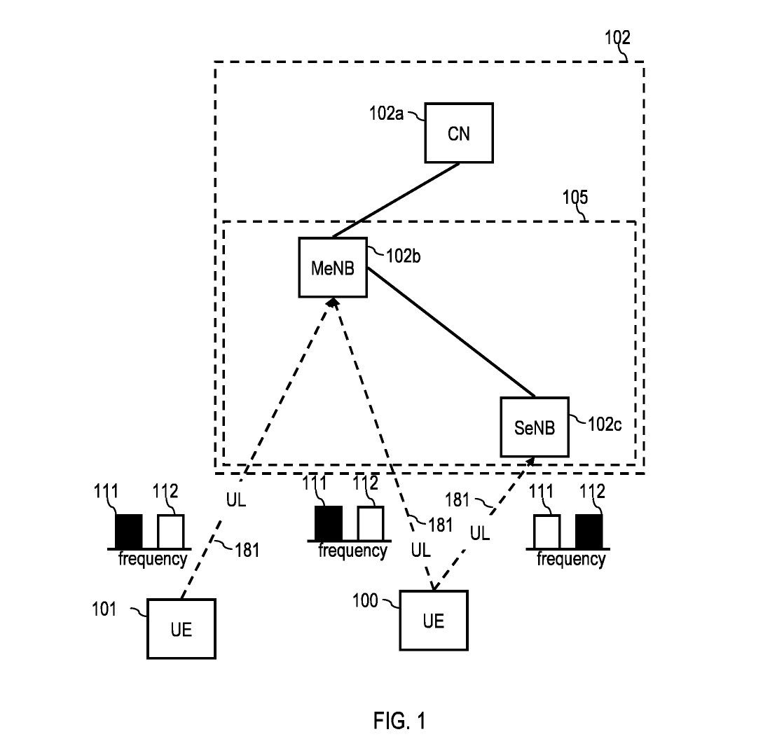

In FIG. 1, a DC scenario according to the 3GPP LTE radio access technology is shown. A UE 100 establishes uplink transmission 181 with two evolved node Bs (eNB), i.e., a master eNB (MeNB) 102b and a secondary eNB (SeNB) 102c of a cellular network 102. E.g., the UE 100 can be one of a group comprising a mobile phone, a smartphone, a tablet, a personal digital assistant, a mobile music player, a smart watch, a wearable electronic equipment, and a mobile computer.

The backhaul link between the MeNB 102b and the SeNB 102c is shown in FIG. 1 (shown in FIG. 1 with a full line). Further, the MeNB 102b is connected to a core network 102a of the cellular network 102. The MeNB 102b and the SeNB 102c form an air interface 105 of the cellular network 102.

Communication between the UE 100 and the MeNB 102b employs a first frequency 111. Communication between the UE 100 and the SeNB 102c employs a second frequency 112, the second frequency 112 being different than the first frequency 111 (non-co-channel deployment scenario). Support of DC in the non-co-channel deployment scenario as illustrated in FIG. 1 has benefits in terms of user data throughput and mobility robustness. Generally, potential benefits of DC scenario include support of inter-node carrier aggregation and a reduced number of handovers.

In FIG. 1, a further UE 101 is shown, which also establishes uplink transmission 181 with the MeNB 102b via the first frequency 111. Resources are typically allocated between the UE 100 and the further UE 101.

The UE 100 has a single RF-TX, i.e., only supports a single carrier for the uplink transmission 181. It is possible that the UE 100 supports dual carrier for donwlink transmission (not shown in FIG. 1); i.e., it is possible that the UE 100 comprises two separate RF-receiving stages (RF-RXs). Because the UE 100 has a single RF-TX and two RF-RXs, the UE 100 may also be referred to as a medium-RF-capability UE.

Since the UE 100 has a single RF-TX, the UE 100 is only able to connect to either the MeNB or the SeNB 102c for the uplink transmission 181 at any one moment in time. From time to time, the UE 100 is required to switch between the first frequency 111 and the second frequency 112 (switching event), i.e., switch between the uplink transmission 181 to the MeNB 102b and the uplink transmission 181 to the SeNB 102c. The switching event may be referred to as RF retuning. Switching requires a certain switching time; e.g., the switching time may amount to approximately 0.5 ms or less; also longer switching times are possible.

Hereinafter, techniques will be illustrated in detail, which allow increasing throughput of uplink control information on an uplink control channel even in view of the switching time which blocks a certain amount of resources of the uplink transmission.

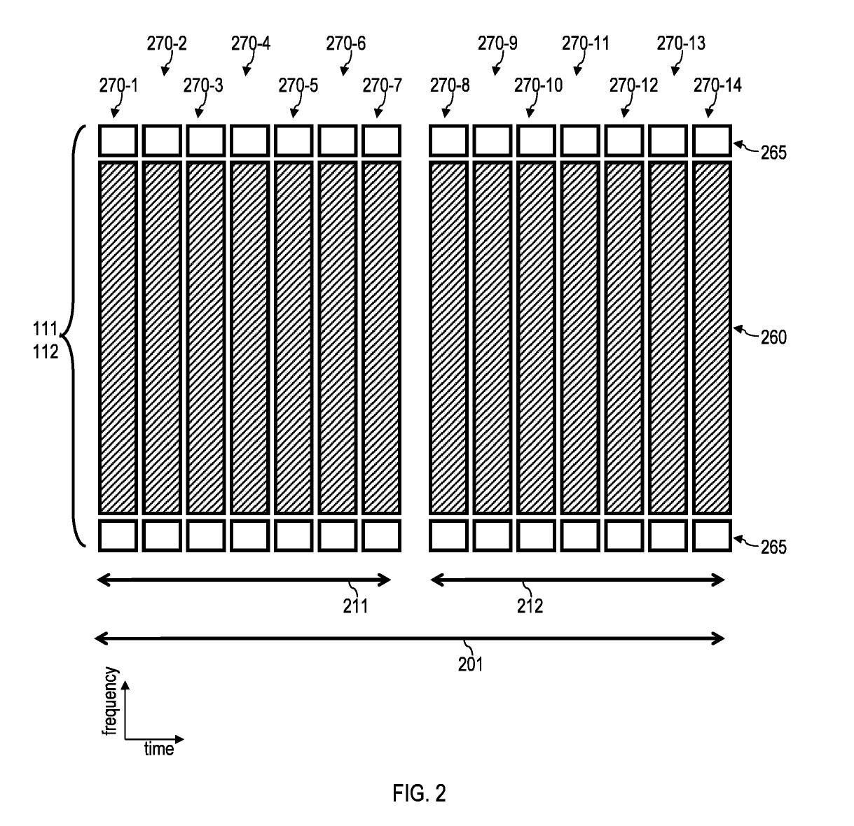

In FIG. 2, the subframe 201 is shown; the subframe 201 includes the slot 211 and the further slot 212. In the embodiment of FIG. 2, the slot 211 precedes the further slot 212 in time (illustrated along the horizontal axis in FIG. 2). In general, the slot 211 may precede or succeed the further slot 212.

The slot 211 includes seven symbols 270-1-270-7; the further slot 212 includes seven symbols 270-8-270-14. Each symbol includes an uplink control channel (PUCCH) 265 and a data channel (PUSCH) 260; the PUSCH 260 carries uplink (UL) payload data, e.g., higher-layer application data or the like. The PUCCH includes the UL control information (UCI). E.g., acknowledgements (ACKs) such as positive acknowledgements (PACKs) or negative acknowledgements (NACKs) may be indicated by the UCI. Block acknowledgement techniques (BACK) may be employed. Said ACKs may acknowledge downlink (DL) payload data packets. Such ACKs may be helpful for a data link layer of the UE 100 to control the UL transmission; in particular Automatic Repeat Request (ARQ) techniques may be employed. Which subframe 201 carries information for which DL payload data packet is sometimes referred to as resource block mapping.

The symbols 270-1-270-14 correspond to a certain frequency (illustrated along the vertical axis in FIG. 2) 111, 112. Depending on whether the subframe 201 is sent to the MeNB 102b or the SeNB 102c, the first frequency 111 or the second frequency 112 is employed. Different resource elements (not shown in FIG. 2) have a well-defined time-frequency position. For the PUCCH 265, resource elements are allocated on the edges of the employed frequency band. While the symbols 270-1-270-14 in fact span a certain frequency bandwidth, hereinafter, for sake of simplicity, reference is made to the frequencies 111, 112.

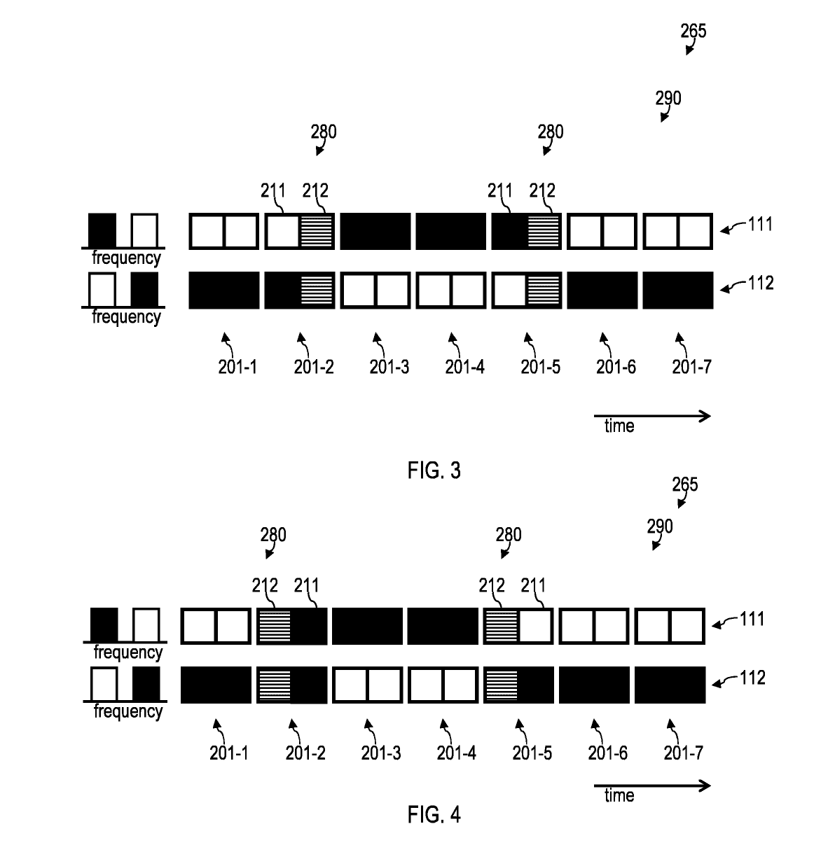

According to various embodiments, the subframe 201 selectively includes the PUCCH 265 in the slot 211—and not in the further slot 212 as illustrated in FIG. 3. In FIG. 3, a sequence 290 of subframes 201-1-201-7 is shown. Each subframe 201-1-201-7 has two slots 211, 212.

In the first subframe 201-1, the UL transmission 181 occurs between the UE 100 and the SeNB 102c via the second frequency 112 (shown in FIG. 3 by the solidly filled squares). Then, during the further slot 212 of the second subframe 201-2 of the sequence 290, a switching event 280 occurs. Because of this, the UL transmission 181 from the UE 100 to the cellular network 102 is muted in the further slot 212 of the second subframe 101-2 (shown by the dashed filling in FIG. 3). In detail, during the further slot 212 of the second subframe 201-2, a wireless interface of the UE 100 switches between the first frequency 111 for the UL transmission 181 to the cellular network 102 and the second frequency 112 for the UL transmission 181 to the cellular network 102. In particular, the wireless interface of the UE 100 switches from the second frequency 112 to the first frequency 111. I.e., communication with the cellular network 102 occurs via the SeNB 102c prior to the switching event 280 and via the MeNB 102b following the switching event 280.

Because of this, during the third subframe 201-3 of the sequence 290 and the fourth subframe 201-4 of the sequence 290, the UL transmission 181 from the UE 100 to the cellular network 102 occurs via the first frequency 111.

Then, in the fifth subframe 201-5 of the sequence 290, a further switching event 280 occurs. In detail, the switching event 280 occurs during the further slot 212 of the fifth subframe 201-5 of the sequence 290. Again, during the further slot 212 of the fifth 201-5, the wireless interface of the UE 100 mutes the UL transmission 181 and switches from the first frequency 111 to the second frequency 112. Then, the UL transmission 181 commences in a sixth and seventh subframe 201-6, 201-7 of the sequence 290 via the second frequency 112, i.e., from the UE 100 to the SeNB 102c.

Hence, as can be seen from FIG. 3, the UL transmission 181 is altered between the MeNB 102b and the SeNB 102c from time to time in a TDM manner. This is because of the single RF-TX of the UE 100. In the scenario of FIG. 3, because of the switching events 280, there are fewer subframes 201, 201-1-201-7 available for the transmission of the UCI via the PUCCH 265.

Generally, the switching events 280 may occur strictly periodically or statistically distributed over time. At any case, an average time interval between subsequent switching events 280 may be referred to as switching period. For switching periods of in the order of, e.g., 0.1 seconds, a capacity loss of approximately 20% for transmission of the UCI may result for reference implementations. As mentioned above, as the UCI can carry ACKs; then, the latency for receiving the ACKs (feedback delay) for DL transmission by the cellular network 102 may increase significantly for reference implementations. Further, it may be required to group more individual ACKs into BACKs; this may reduce a reliability of the ARQ techniques.

This is because, according to reference implementations, the PUCCH 265 is required to occupy the entire subframe 201-1-201-7 (cf. FIG. 2). Thus, during a subframe 201-1-201-7 coinciding with one of the switching events 280, it is not possible to transmit the PUCCH 265, i.e., UCI cannot be transmitted.

According to various embodiments, during the slot 211 of the second subframe 201-2 and during the slot 211 of the fifth subframe 201-5, a truncated PUCCH format is employed. Namely, the slots 211 of the second and fifth subframes 201-2, 201-5 selectively include the PUCCH 265 in the slot 211, respectively. Thus, the truncated PUCCH format can be transmitted in half a subframe 201, 201-1-201-7.

By relying on the truncated PUCCH format, an average transmission capacity of the PUCCH 265 can be increased. This may allow, in turn, reducing a number of BACKs employed while, on the other hand, individual ACKs may be employed more frequently to acknowledge DL data packets. The feedback delay may be reduced.

In FIG. 4, a scenario is shown where the truncated PUCCH format is transmitted in the last slot of the subframe 201, 201-1-201-7. Here, the slot 211 succeeds the further slot 212 in time.

In such scenarios as mentioned above, the decision logic regarding which particular slot 211, 212 of the subframes 201-1-201-7 of the sequence 290 is utilized for the truncated PUCCH format resides within the cellular network 102, e.g., within the MeNB 102b.

The occurrence of the switching events 280, i.e., of the slot 211 including the truncated PUCCH format, may be anticipated by the UE 100. Thus, it is possible to include the PUCCH 265 in the slot 211 in response to a need of switching between the first frequency 111 and the second frequency 112 in the further slot. It is possible that the cellular network 102 is prospectively informed on the occurrence of the switching event 280, i.e., of the slot 211 including the truncated PUCCH format. It is possible that a processor of the UE 100 is configured to negotiate an occurrence of the switching events 280, i.e., of the slot 211 including the truncated PUCCH format, with the cellular network 102. It is also possible that the occurrence of the slot 211 of the subframe 201, 201-1-201-7 which selectively includes the PUCCH 265 is negotiated with the cellular network 102. It is also possible that the cellular network 102 prospectively commands the UE 100 when to execute the switching events 280. Thus, the cellular network 102 may specify the occurrence of the switching events 280. This can be done according to specific pre-configured rules, e.g., according to the particular radio network temporary identifier (RNPI) employed and/or scheduling needs.

Hence, the decision logic when to execute the switching events 280 may reside fully in the cellular network 102 or may reside fully at the UE 100 or may be shared between the UE 100 and the cellular network 102.

E.g., the occurrence of the switching events 280 may be according to a predefined rule. The switching events 280 can be pre-configured; respective control data may be stored in a memory of the UE 100 and/or a memory of the cellular network 102. E.g., the switching events 280 may be strictly periodic or may be distributed in time according to some other deterministic dependency. The switching events 280 may also be statistically distributed.

In particular, a level of detail with which the occurrence of the slot 211 of the subframe 201, 201-1-201-7 which selectively includes the PUCCH 265, i.e., the truncated PUCCH format, is negotiated may correspond to the position of the subframe 201, 201-1-201-7 in the sequence 290. It is also possible that the level of detail corresponds to the position of the slot 211 within the subframe 201, 201-1-201-7. Thus, respective control messages may include more or less information. E.g., the position of the subframe 201, 201-1-201-7 including the truncated PUCCH format may be dynamically negotiated; while the position of the slot 211 may be predefined according to some rules.

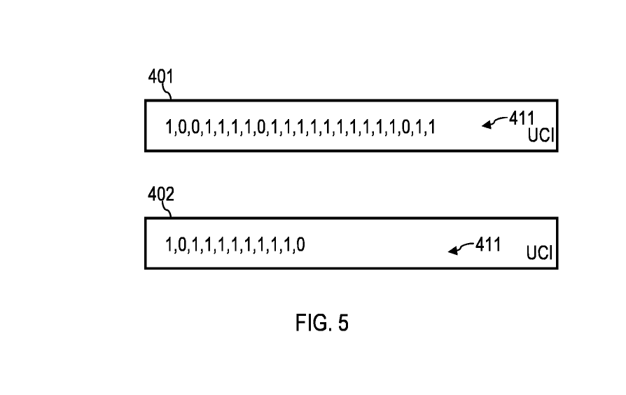

Generally, those subframes 201, 201-1-201-7 that do not coincide with a switching event 280, i.e., in FIGS. 3 and 4 the first, third, fourth, sixth, and seventh subframes 201-1, 201-3, 201-4, 201-6, 201-7, can rely on a PUCCH format according to reference implementations, e.g., PUCCH format 3 as specified by 3GPP Technical Specification (TS) 36.211, version 12.3 of Sep. 26, 2014, chapter 5.4.2A; From FIG. 5.4.3-1 “Mapping to physical resource blocks for PUCCH” it can be seen that the subframe includes the PUCCH in both slots.

Thus, generally speaking, both, a slot 211 and a further slot 212 of a further subframe 201, 201-1-201-7 may include the PUCCH 265. The further subframe 201, 201-1-201-7 may be adjacent to the subframe 201, 201-1-201-7 comprising the further slot 212 during which the UL transmission 181 is muted in the sequence 290 of subframes 201, 201-1-201-7. Hence, adjacent to a subframe 201, 201-1-201-7 including the truncated PUCCH format, a further subframe 201, 201-1-201-7 may be transmitted including the PUCCH format 3.

In FIG. 5, the UCI 401, 402 is illustrated. The UCI 401 includes twenty-one bits 411 of information, i.e., raw information bits. Differently, the UCI 402 includes only eleven bits 411 of information. Each bit 411 can correspond to an ACK of a DL data packet or Scheduling Request bit (not shown in FIG. 5), i.e., correspond to raw information. E.g., the truncated PUCCH format may encode eleven bits 411 or less corresponding to ACKs of DL data packets transmitted from the cellular network 102 to the UE 100; the conventional PUCCH 3 format can encode, e.g., more than twelve bits 411 corresponding to ACKs of DL data packets transmitted from the cellular network 102 to the UE 100.

In the conventional PUCCH format 3, ACK/NACK bits, from up to five component carriers, at most two bits for each component carrier, along with a scheduling request bit (if present) are raw information bits. These raw information bits 411 are typically first concatenated into a sequence of bits. Then block coding will be applied, followed by scrambling to result in fourty-eight bits, which will be Quadrature Phase-Shift Keying (QPSK)-modulated to yield twenty-four QPSK symbols. The twenty-four symbols will be divided into two groups to fit two slots, therefore typically twelve QPSK symbols are included per slot. The truncated PUCCH format can, in contrast, include twelve QPSK-modulated bits per entire subframe.

It should be appreciated that there is no direct mapping between the coded bits and the raw-information bits 411, e.g., ACKs and NACKs, since there is a block coding and scrambling process.

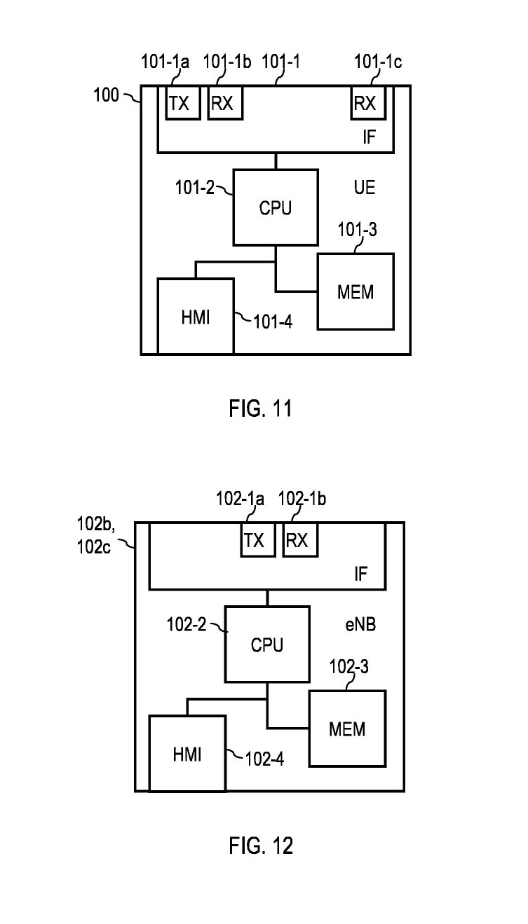

The encoding scheme of the conventional PUCCH format 3 is shown in FIG. 11.25 of “4G LTE/LTE-Advanced for Mobile Broadband” by E. Dahlman, S. Parkvall, and J. Sköld, Second Edition (2014) Academic Press. Here, the same structure of encoding is used in the first and further slots where the initial twelve (QPSK symbols as mentioned are spread out in five symbols of the first slot of the subframe while the last twelve QPSK symbols are spread to the second slot of the subframe.

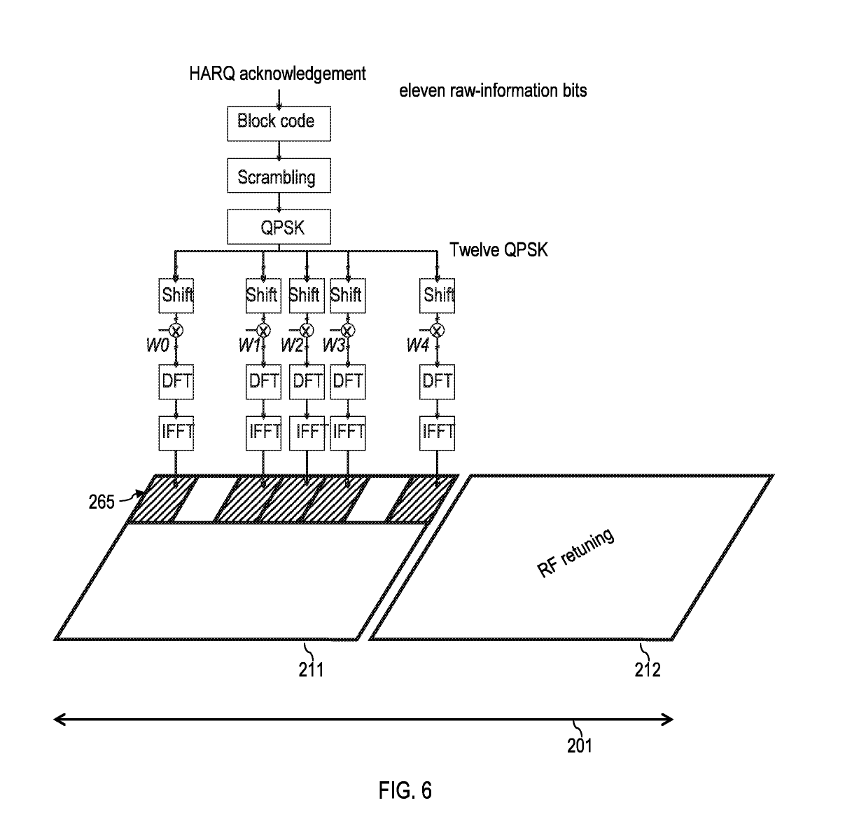

Generally, the truncated PUCCH format can be designed to be compatible with PUCCH format 3. E.g., the truncated PUCCH format can employ a similar encoding technique as PUCCH format 3, see FIG. 6. Here, Discreet Fourier Transform (DFT)-precoded ODFM is employed. However, only twelve QPSK-bits are encoded and only half the subframe 201, 201-1-201-7 is occupied, i.e., only the slot 211. Thus, an energy per raw-information bit 411 may remain approximately constant. The further slot 212 can be used for RF retuning.

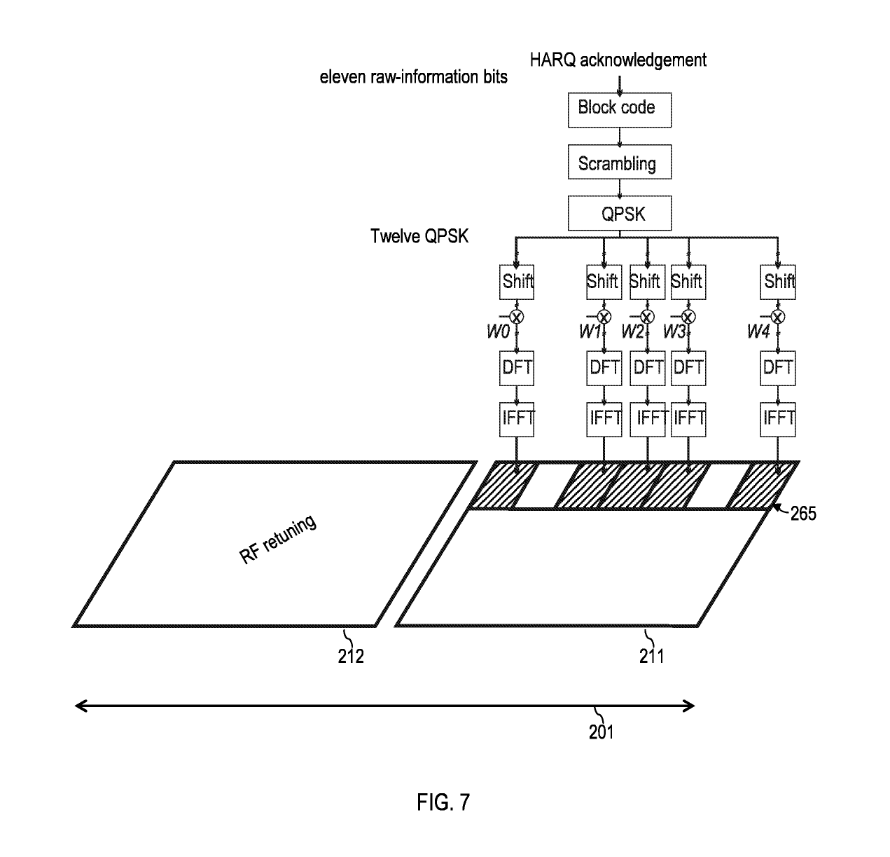

A corresponding scenario is shown in FIG. 7 where the further slot 212 precedes the slot 211.

In FIGS. 6 and 7, a Hybrid ARQ (HARQ) ACK positively or negatively acknowledges several DL data packets, i.e., BACK is employed. E.g., it is possible to encode eleven raw-information bits 411 employing the truncated PUCCH format. The DL data packets can correspond to DL payload data included in a certain downlink subframe. The HARQ ACK may be concatenated with a scheduling request (SR) bit into a sequence of bits. Thus, if the UE 100 needs to send the SR, the SR can be multiplexed with the HARQ ACK.

Then, block coding is applied, followed by scrambling sequence to randomize inter-cell interference. By such techniques, twelve bits or twenty-four bits result, depending on the amount of raw-information bits 411, such as HARQ ACKs etc., that are encoded. These bits are QPSK modulated and, in case of the truncated PUCCH format, transmitted in the slot 211 of the subframe 201, 201-1-201-7.

Typically, e.g. in the case of a normal cyclic prefix, there are seven OFDM symbols per slot 211, 212 used for the UL transmission 181, 182. The truncated PUCCH format employs—in a manner comparable to the PUCCH format 3—two OFDM symbols in the slot 211 of the subframe 201, 201-1, 201-7 for transmission of a channel reference signal. In case of an extended cyclic prefix, only one OFDM symbol is employed for the transmission of the channel reference signal. Five OFDM symbols of the slot 211 are employed for transmission of the UCI 401, 402 (shown with the dashed filling in FIGS. 6 and 7).

To increase the multiplexing capacity, similarly to the PUCCH format 3, a length-five orthogonal sequence (labelled W0, W1, W2, W3, Ww4 in FIGS. 6 and 7) is used with each of the five OFDM symbols used for transmission of the UCI 401, 402. This allows up to ten UEs 100, 101 to share the same resource block of the truncated PUCCH format, respectively of PUCCH format 3. In particular, it is possible that the UE 100 sends, during a given subframe 201, 201-1-201-7, the truncated PUCCH format employing a first orthogonal sequence and the further UE 101 sends, during the given subframe 201, 201-1-201-7, the PUCCH format 3 employing a second orthogonal sequence, the first and second orthogonal sequences being different. Generally speaking, the MeNB 102b and/or the SeNB 102c may receive the subframe 201, 201-1-201-7 from the UE 100 including the truncated PUCCH format, i.e., selectively including the PUCCH 265 in the slot 211; and the MeNB 102b and/or the SeNB 102c may receive a further subframe from the further UE 101 including the PUCCH 265 in, both, the slot 211 and the further slot 212, wherein the subframe 201, 201-1-201-7 and the further subframe are synchronized in time. E.g., the further subframe 201, 201-1-201-7 may include the PUCCH 265 according to PUCCH format 3.

As can be seen from FIGS. 6 and 7, the encoding scheme of the truncated PUCCH format is comparable to the encoding scheme used for PUCCH format 3. This enables to share one and the same resource block between the UE 100 employing the truncated PUCCH format and the further UE 101 which may employ the PUCCH format 3. E.g., the length-5 orthogonal sequence W0. . . W4 may be set differently for the further UE 101 and the UE 100.

In detail, because of the pre-negotiated occurrence of the slot 211, respectively of the switching events 280, both, the MeNB 102b and SeNB 102c expect the truncated PUCCH format which is selectively transmitted in the slot 211 of the respective subframe 201, 201-1-201-7. In a manner comparable to the PUCCH format 3, a resource can be represented by a single index from which the orthogonal sequence and the resource-block number can be derived. The UE 100 can be configured with four different resources for the truncated PUCCH format. It is possible that the cellular network 102 instructs the UE 100 which one of the four resources is to be used. In such a manner, a scheduler of the cellular network 102 can avoid PUCCH collisions between different UEs 100, 101 by assigning different resources to the different UEs. Hence, the same resource block can be used in a code division multiplex (CDM) manner and up to five UEs configured with PUCCH format 3 or ten UEs configured with the truncated PUCCH format can share the same resource block.

It is also possible that switching events 280 of the UE 100 and the further UE 101 are scheduled coherently. E.g., a switching event 280 of the further UE 101 may occur during the slot 211 of the subframe; while the switching event 280 of the UE 100 may occur during the further slot 212 of the subframe 201, 201-1-201-7. Then, the further UE 101 may employ the truncated PUCCH format during the further slot 212 of the subframe 201, 201-1-201-7. I.e., the further UE 101 may send a further subframe 201, 201-1-201-7 selectively including the PUCCH 265 in the further slot 212; while the UE 100 send the subframe 201, 201-1-201-7 selectively including the PUCCH 265 in the slot 211, the subframe 201, 201-1-201-7 and the further subframe 201, 201-1-201-7 being synchronized in time.

E.g., the cellular network 102 may receive a further slot 212 of further subframe 201, 201-1-201-6 from the further UE 101, the further subframe 201, 201-1-201-6 selectively including the PUCCH 265 in the further slot 212; the subframe 201, 201-1-201-7 and the further subframe 201, 201-1-201-7 can be synchronized in time and employ the same frequency 111, 112.

Hereinafter, techniques of resource block mapping are illustrated.

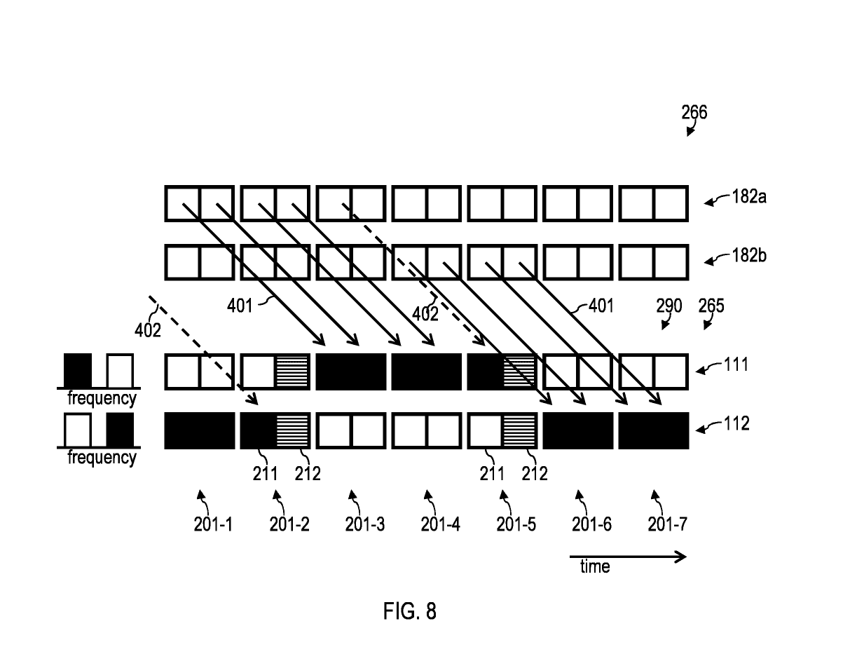

In FIG. 8, the resource block mapping is illustrated. In FIG.8, top part, the Physical Downlink Shared Channel (PDSCH) 266 is shown for the DL transmission 182a from the MeNB 102b to the UE 100 and for the DL transmission 182b from the SeNB 102c to the UE 100. Because the wireless interface of the UE 100 comprises two separate RF-RXs, the DL transmission 182a, 182b from the MeNB 102b and from the SeNB 102c can occur simultaneously employing two different frequencies (not shown in FIG.8).

HARQ ACKs for the subframes of the two PDSCHs 266 are sent via the PUCCH 265. Corresponding UCI 401, 402 is included in the subframes 201, 201-1-201-7 of the PUCCH 265. As can be seen from FIG. 8, it is not possible to send the subframe 201, 201-1-201-7 of the PUCCH 265 at a given moment in time on, both, the first frequency 111 and the second frequency 112, i.e., to, both, the MeNB 102b and the SeNB 102c as the UE 100 only has a single RF-TX. The switching events 280 correspond to switching between the first and second frequencies 111, 112.

The first, second, and third subframes 201-1, 201-3, 201-4, as well as the sixth and seventh subframes 201-6, 201-7 include the PUCCH format 3. The corresponding UCI 401 encodes twenty-four bits 411 of raw information (cf. FIG. 5). Differently, the UCI 402 included in the PUCCH 265 during the slot 211 of the second and fifth subframes 201-2, 201-5 encodes twelve bits 411 of raw information (illustrated in FIG. 8 by the dashed diagonal arrow). It is possible that the UCI 401 sent via the PUCCH 265 in a subframe 201, 201-1-201-7 succeeding a switching event 280 is a BACK of the preceding DL subframes of the PDSCH 266 of the respective DL transmission 182a, 182b.

Generally, while the further slot 212 of the fifth subframe 201-5 is not used for UL transmission 181 from the UE 100 to the cellular network 102, it is possible that the further slot 212 of the fifth subframe 201-5 is reserved to be utilized for other DC UEs to avoid collisions between PUCCH format 3 and the truncated PUCCH format.

Multiple resource-block pairs can be used to increase the control signal capacity. In a scenario where one resource-block pair is full, the next PUCCH resource index is mapped to the next resource-block pair in sequence. The location of the truncated PUCCH format is the same as PUCCH format 3 to reduce implementation complexity. Hence, the capacity of the truncated PUCCH format can be increased.

Hereinafter, aspects of the transmit power are discussed.

Transmit power of the truncated PUCCH format is discussed below. For every resource block, it is assumed that the same transmit power E_{RB} is employed; in other words, E_{RB} is the energy or power budget per user and per resource block. For the PUCCH format 3 according to various reference implementations, it is assumed that there are five UEs which share the same resource-block pair. It is assumed that twenty-one raw-information bits 411 of UCI 401, 402 should be transmitted, e.g., including twenty bits 411 of HARQ ACKs and one bit for SR. It is possible that the eleven raw-information bits 411 correspond to twenty-four coded bits and twelve QPSK symbols. Then, the transmit power of each raw-information bit 401 is given by:

$${E}_{δ} = \frac{2 * {E}_{RB}}{21} . \qquad ( 1 )$$

The factor two in the enumerator of the fraction of Eq. 1 arises from the PUCCH format 3 occupying the slot 211 and the further slot 212 of a subframe 201, 201-1-201-7. Different UEs may have separate power budgets.

For the truncated PUCCH format, it may also be assumed that five UEs share the same resource block. Eleven raw-information bits 411 of UCI 402 are transmitted, e.g., ten bits of HARQ ACKs and one bit for SR. Then the transmit power of each bit is given by:

$${E}_{new} = \frac{{E}_{RB}}{11} . \qquad ( 2 )$$

In the above, it can be seen that the difference between the transmit power per raw-information bit 401 according PUCCH format 3 is small if compared to a transmit power per raw-information bit 401 according to a truncated PUCCH format. Thus, the truncated PUCCH format has little impact on transmission performance compared to PUCCH format 3.

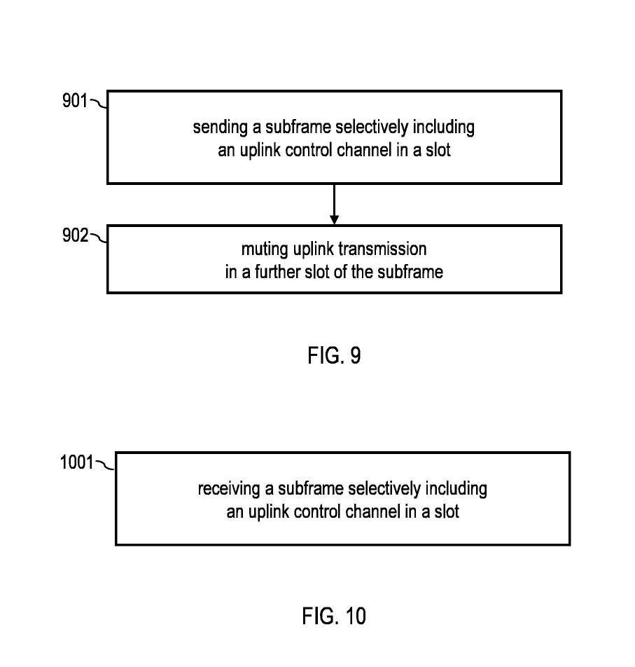

In FIG. 9, a flowchart of a method of sending the subframe 201, 201-1-201-7 is illustrated. At 901, the subframe 201, 201-1-201-7 is sent by a processor of the UE 100 via the wireless interface of the UE 100. In the slot 211, the subframe 201, 201-1-201-7 includes the PUCCH 265. The PUCCH 265 indicates the UCI 401, 402. The subframe 201, 201-1-201-7 does not include the PUCCH 265 in the further slot 212.

At 902, during the further slot 212 of the subframe 201, 201-1-201-7, the UL transmission 181 from the UE 100 to the cellular network 102 is muted. E.g., during the further slot 212, the UE 100 can retune the frequency 111, 112 to enable DC even though the wireless interface only includes a single RF-TX. Here, a switching event 280 may occur.

Generally, 901 can precede or succeed 902; i.e., it is possible that the switching event 280 occurs in the first half or the second half of the subframe 201, 201-1-201-7; i.e., the slot 211 may precede or succeed the further slot 212.

In FIG. 10, a flowchart of a method of receiving the subframe 201, 201-1-201-7 is shown. At 1001, the subframe 201, 201-1-201-7 is received. The subframe 201, 201-1-201-7 selectively includes the PUCCH 265 in the slot 211; i.e., the subframe 201, 201-1-201-7 does not include the PUCCH 265 in the further slot 212.

In FIG. 11, the UE 100 is shown at greater detail. The UE 100 comprises the wireless interface 101-1. The wireless interface 101-1 comprises two RF-RXs 101-1b, 101-1c that can be employed for DL transmission 182a, 182b and a single RF-TX 101-1a which can be employed for the UL transmission 181.

The UE 100 further comprises the processor 101-2 coupled to a memory 101-3, e.g., a non-volatile memory. The memory 101-3 can include control data which can be executed by the processor 101-2. Executing the control data can cause the processor 101-2 to perform techniques of sending the subframe 201, 201-1-201-7 as discussed above.

The UE 100 further includes a human-machine interface (HMI) 101-4. Via the HMI 101-4, it is possible to output information to a user and receive information from the user.

In FIG. 12, the MeNB 102b and the SeNB 102c are schematically illustrated. Each one of the MeNB 102b and the SeNB 102c include a RF-TX 102-1a and RF-TX 102-1b. E.g., the MeNB 102b handles the DL transmission 182a while the SeNB 102c handles the DL transmission 182b. The RF-TX 102-1a of the MeNB 102b is configured to establish the UL transmission 181 with the UE 100 via the first frequency 111; likewise, the RF-RX chain 102-1b of the SeNB 102c is configured to establish the UL transmission 181 with the UE 100 via the second frequency 112.

The MeNB 102b and the SeNB 102c could be co-located. In such a scenario, the combined eNB could include, both, the RF-RXs 102-1b that support the UL transmission 181 via the first and second frequencies 111, 112.

The MeNB 102b and the SeNB 102c further include a processor 102-2 and a non-volatile memory 102-3. Control data can be stored on the memory 102-3; executing the control data can cause the processor 102-2 to perform techniques of receiving the subframe 201, 201-1-201-7 as discussed above.

The MeNB 102b and the SeNB 102c further include an HMI 102-4. Via the HMI 102-4, it is possible to output information to a user and receive information from the user.

As will be appreciated from the above, techniques of a truncated PUCCH format have been discussed. In particular, a subframe is sent which selectively includes the PUCCH in one of the two slots, i.e., the subframe does not include the PUCCH in the other one of the two slots. The truncated PUCCH format can be structured according to the PUCCH format 3.

The truncated PUCCH format allows increasing a capacity for transmission of UCI even though switching events block certain resource elements. However, beyond increasing UE throughput by increasing a number of usable UL subframes, further effects on system performance can be achieved. UL resources can be utilized to a larger degree due to the availability of HARQ ACKs in subframes which coincide with the switching event; thus DL scheduling flexibility is typically less impacted, because the cellular network can schedule DL transmission earlier if the feedback delay is decreased. Further, latency can be reduced. As a further effect, BACKs are required for a smaller number of DL subframes; this allows decreasing the HARQ roundtrip time which, in turn, results in a decreased soft buffer size and less UE throughput loss if compared to reference implementations. Due to the increased availability of DL HARQ processes, in general fewer DL transmissions of new data to the UE are stalled or delayed. This may have a significant impact on data throughput and system capacity. As a further effect, encoding and decoding techniques previously known in the context of the PUCCH format 3 may be re-used. Thereby, an implementation complexity at the UE and the cellular network can be reduced. Further, if the number of raw-information bits of the UCI included in the PUCCH of the slot of the subframe is limited, e.g., to a number of eleven, a reliability of the transmission can be maintained at a level comparable to the PUCCH format 3 without a need for increasing a transmit power. Still further, it is possible to share resource blocks between the PUCCH included in subframes according to various reference implementations, e.g., PUCCH format 3, and the truncated PUCCH format as discussed herein; thereby, a corresponding mapping procedure can be re-used which allows to reduce the complexity of PUCCH resource allocation.

Generally, the truncated PUCCH format can be transmitted at either slot of a subframe during which the retuning event occurs. The cellular network may decide which one of the two slots of the corresponding subframe is used for the PUCCH transmission; for this, specific rules may be implemented, e.g., according to the cell radio network temporary identity of the UE and/or scheduling needs. Thereby, a system capacity may be improved and the scheduling flexibility or the cellular network may increase.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

E.g., reference has been primarily made to scenarios where the muting of the uplink transmission during the further slot of the subframe is due to a switching event. However, in general it is possible that the muting of the uplink transmission during the further slot of the subframe is caused by a different event, e.g., a re-initialization of the RF-TX of the UE, re-initialization of a transmit buffer of the UE, etc.

Further, it is to be understood that while the slots of the subframe are referred to as slot and further slot, it is generally possible that the slot precedes or succeeds the further slot in time; it is generally possible that the slot and further slot are adjacent in a stream of slots and that the slot is arranged before or after the further slot in the stream of slots.

1. A communication device , comprising:
a wireless interface configured to communicate with a cellular network,
at least one processor configured to send, via the wireless interface, a slot of a subframe, the subframe selectively including an uplink control channel in the slot,
wherein the wireless interface is configured to mute uplink transmission to the cellular network in a further slot of the subframe.

2. The communication device of claim 1,
wherein the wireless interface is configured to switch, during the further slot of the subframe, between a first frequency for the uplink transmission to the cellular network and a second frequency for the uplink transmission to the cellular network.

3. The communication device of claim 2,
wherein the at least one processor is configured to selectively include the uplink control channel in the slot in response to a need of the wireless interface switching between the first frequency and the second frequency in the further slot.

4. The communication device of claim 1,
wherein the at least one processor is configured to prospectively negotiate with the cellular network, via the wireless interface, an occurrence of the slot of the subframe.

5. The communication device of claim 4,
wherein the negotiated occurrence of the slot of the subframe indicates at least one of a position of the slot in the subframe and a position of the subframe in a sequence of subframes of the uplink transmission.

6. The communication device of claim 1,
wherein the at least one processor is configured to send a slot and a further slot of a further subframe, the further subframe including the uplink control channel in the slot and in the further slot, the further subframe being adjacent to the subframe in a sequence of subframes of the uplink transmission,
wherein the uplink control channel of the further subframe includes uplink control information encoding at least twenty bits corresponding to acknowledgement of at least one downlink data packet transmitted from the cellular network to the communication device as downlink transmission.

7. The communication device of claim 1,
wherein the uplink control channel of the subframe includes uplink control information encoding twelve bits or less corresponding to acknowledgement of at least one downlink data packet transmitted from the cellular network to the communication device as downlink transmission.

8. The communication device of claim 1,
wherein the communication device is a mobile device of a group comprising a mobile phone, a smartphone, a tablet, a personal digital assistant, a mobile music player, a smart watch, a wearable electronic equipment, and a mobile computer.

9. The communication device of claim 1,
wherein the slot of the subframe precedes or succeeds the further slot of the subframe in time.

10. A method, comprising:
at least one processor of a communication device sending, via a wireless interface of the communication device, a slot of a subframe, the subframe selectively including an uplink control channel in the slot,
the wireless interface muting uplink transmission to the cellular network in a further slot of the subframe.

11. The method of claim 10, further comprising:
the wireless interface switching, during the further slot of the subframe, between a first frequency for the uplink transmission to the cellular network and a second frequency for the uplink transmission.

12. The method of claim 11,
wherein the uplink control channel is selectively included in the slot of the subframe in response to a need of the wireless interface switching between the first frequency and the second frequency in the further slot.

13. The method of claim 10, further comprising:
the at least one processor prospectively negotiating with the cellular network, via the wireless interface, an occurrence of the slot of the subframe.

14. The method of claim 13,
wherein the negotiated occurrence of the slot indicates at least one of a position of the slot in the subframe and a position of the subframe in a sequence of subframes of the uplink transmission.

15. The method of claim 10, further comprising:
the at least one processor sending a slot and a further slot of a further subframe, the further subframe including the uplink control channel in the slot and in the further slot, the further subframe being adjacent to the subframe in a sequence of subframes of the uplink transmission,
wherein the uplink control channel of the further subframe includes uplink control information encoding at least twenty bits corresponding to acknowledgements for at least one downlink data packet transmitted from the cellular network to the communication device as downlink transmission.

16. The method of claim 10,
wherein the uplink control channel of the subframe includes uplink control information encoding twelve bits or less corresponding to acknowledgements for at least one downlink data packet transmitted from the cellular network to the communication device as downlink transmission.

17. The method of claim 10,
wherein the slot of the subframe precedes or succeeds the further slot of the subframe in time.

18. An air interface of a cellular network, comprising:
at least one access node configured to communicate with a communication device,
at least one processor configured to receive, via a wireless interface of the at least one access node, a slot of a subframe from the communication device, the subframe selectively including an uplink control channel in the slot.

19. The air interface of claim 18,
wherein uplink transmission of the subframe employs a first frequency,
wherein the at least one processor is further configured to receive, via the wireless interface of the at least one access node, a slot and a further slot of a further subframe, the further subframe including the uplink control channel in the slot and in the further slot, the further subframe being adjacent to the subframe in a sequence of subframes of the uplink transmission,
wherein the uplink transmission of the further subframe employs a second frequency, the second frequency being different than the first frequency.

20. The air interface of claim 19,
wherein the uplink control channel of the subframe includes uplink control encoding twelve bits or less corresponding to acknowledgement of at least one downlink data packet transmitted from the cellular network to the communication device as downlink transmission,
wherein the uplink control channel of the further subframe includes uplink control information encoding at least twenty bits corresponding to acknowledgement of the at least one downlink data packet transmitted from the cellular network to the communication device as the downlink transmission.

21. The air interface of claim 18,
wherein the at least one processor is configured to not receive, via the wireless interface of the at least one access node, the uplink control channel in a further slot of the subframe,
wherein the slot of the subframe precedes or succeeds the further slot of the subframe in time.

22. The air interface of claim 18,
wherein the at least one processor is configured to receive, via the wireless interface of the at least one access node, a slot and a further slot of another subframe from a further communication device, the another subframe including the uplink control channel in the slot and in the further slot,
wherein the subframe and the another subframe are synchronized in time and employ the same frequency.

23. The air interface of claim 18,
wherein the at least one processor is configured to receive, via the wireless interface of the at least one access node, a further slot of another subframe from a further communication device, the another subframe selectively including the uplink control channel in the further slot,
wherein the subframe and the another subframe are synchronized in time and employ the same frequency.

24. The air interface of claim 18,
wherein the at least one processor is configured to prospectively negotiate with the communication device, via the wireless interface of the at least one access node, an occurrence of the slot of the subframe.

25. The air interface of claim 23,
wherein the at least one processor is configured to prospectively negotiate with the communication device and the further communication, via the wireless interface of the at least one access node, an occurrence of the slot of the subframe and an occurrence of the further slot of the another subframe.

26. The air interface of claim 25,
wherein the negotiated occurrence of the slot and/or the further slot indicates at least one of a position of the slot in the subframe and/or a position of the further slot in the another subframe and a position of the subframe and the another subframe in a sequence of subframes of an uplink transmission.

27. A method, comprising:
at least one processor of an air interface of a cellular network receiving, via a wireless interface of at least one access node of the air interface, a slot of a subframe from a communication device, the subframe selectively including an uplink control channel in the slot.

28. The method of claim 27,
wherein uplink transmission of the subframe employs a first frequency, the method further comprising:
the at least one processor receiving, via the wireless interface of the at least one access node, a slot and a further slot of a further subframe, the further subframe including the uplink control channel in the slot and in the further slot, the further subframe being adjacent to the subframe in a sequence of subframes of the uplink transmission,
wherein the uplink transmission of the further subframe employs a second frequency, the second frequency being different than the first frequency.

29. The method of claim 28,
wherein the uplink control channel of the subframe includes uplink control information encoding twelve bits or less corresponding to acknowledgement of at least one downlink data packet transmitted from the cellular network to the communication device as downlink transmission,
wherein the uplink control channel of the further subframe includes uplink control information encoding at least twenty bits corresponding to acknowledgement of the at least one downlink data packet transmitted from the cellular network to the communication device as the downlink transmission.

30. The method of claim 27, further comprising:
the at least one processor not receiving, via the wireless interface of the at least one access node, the uplink control channel in a further slot of the subframe,
wherein the slot of the subframe precedes or succeeds the further slot of the subframe in time.

31. The method of claim 27, further comprising:
the at least one processor receiving, via the wireless interface of the at least one access node, a slot and a further slot of another subframe from a further communication device, the another subframe including the uplink control channel in the slot and in the further slot,
wherein the subframe and the another subframe are synchronized in time and employ the same frequency.

32. The method of claim 27, further comprising:
the at least one processor receiving, via a wireless interface of the at least one access node, a further slot of another subframe from another communication device, the another subframe selectively including the uplink control channel in the further slot,
wherein the subframe and the another subframe are synchronized in time.

33. The method of claim 27, further comprising:
the at least one processor prospectively negotiating with the communication device, via the wireless interface of the at least one access node, an occurrence of the slot of the subframe.

34. The method of claim 32, further comprising:
the at least one processor prospectively negotiating with the communication device and the further communication device, via the wireless interface of the at least one access node, an occurrence of the slot of the subframe and an occurrence of the further slot of the another subframe.

35. A system, comprising:
a communication device, the communication device comprising:
a wireless interface configured to communicate with a cellular network,
at least one processor configured to send, via the wireless interface, a slot of a subframe, the subframe selectively including an uplink control channel in the slot,
wherein the wireless interface of the communication device is configured to mute uplink transmission to the cellular network in a further slot of the subframe,
the system further comprising:
an air interface of the cellular network, the air interface comprising:
at least one access node configured to communicate with the communicate device
at least one processor configured to receive, via a wireless interface of the at least one access node, the slot of the subframe from the communication device.
